(19) United States
(12) Patent Application Publication
(10) Pub. No.: US 2014/0155841 A1
(43) Pub. Date: Jun. 5, 2014

(54) MEDICATION ADHERENCE REMINDER DEVICE

(71) Applicant: Christopher J. Dossin, Cornelius, NC (US)

(72) Inventor: Christopher J. Dossin, Cornelius, NC (US)

(21) Appl. No.: 14/095,940

(22) Filed: Dec. 3, 2013

Related U.S. Application Data
(60) Provisional application No. 61/732,582, filed on Dec. 3, 2012.

(51) Int. Cl. A61J 1/18

(52) U.S. Cl. CPC A61J 1/18
USPC 604/290; 215/365

(57) ABSTRACT

The present invention provides a device for tracking medical dosage schedules. The device includes a generally tubular device that has an inner surface and an outer surface, wherein the outer surface includes visual indicia related to dosing of medication wherein the device is configured to be positioned around a container of the medication. By positioning the device relative to the container, the user can determine which dose has been administered and which dose is next to be administered.

### FIELD OF THE INVENTION

The invention relates generally to a system and apparatus for determining and tracking administration of medication such that medicines are administered in the prescribed amount and at the prescribed time or interval and, more specifically, the invention relates to an apparatus configured to be provided with the medication to a patient.

### BACKGROUND OF THE INVENTION

There are many medications that are administered in multiple doses that are spaced-apart in a prescribed course of treatment or regimen. In addition, many medications are administered in regimens that include other medications that might also require multiple doses. Such regimens can be complicated, and some conditions require these complicated regimens to be administered with accuracy for extended periods of time. For example, patients that have had cataract surgery can be required to take several different eye drops at particular intervals for a period of time reaching three to four weeks or longer. Further complicating matters is the possibility that during the course of a treatment some medications might be administered at a first interval and other medications might be administered at a different, second interval. For the treatment to be effective, the patient must comply with a prescribed dosage amounts and a prescribed time of administration of each dose. Compliance must also continue, i.e. persist, for the prescribed period of time.

Medical compliance, i.e. adherence, is an important component in maximizing the effectives of medical treatment. As used herein, the term “medical compliance” refers to the accuracy with which a caregiver's instructions and medicinal regimens are followed. Another critical component of effective treatment of disease and post-operative care is persistence. As used herein, the term “persistence” refers to the degree to which a patient follows medical instructions over time.

Further complicating matters is that some patients and caregivers might have particular difficulties executing medical instructions. These difficulties can be related to physical disabilities or mental disabilities. Elderly patients in particular can be subject to such disabilities. In countries in which people are living longer on average, this problem with disabilities is exacerbated by the fact that the elderly population is growing.

One problem with some medical instructions is that they are difficult to understand.

Another problem with some medical instructions is that they are complex and as a result, it is difficult to follow each step.

### SUMMARY OF THE INVENTION

According to the present invention, there is provided a device and method for determining dosing intervals. In one embodiment, the device is in the form of an eye drop administration interval ring (the ring). The device is simple, low cost, and freestanding. It is believed that use of the device in accordance to the method provided herein can improve prescription medication compliance and persistency. In this regard, patients or caregivers can utilize device 10 daily to remind them which dose, in some cases drops, has been administered and when the next dose is due. The device is especially helpful when multiple medications are being administered daily or administration is over an extended period (as with chronic diseases such as glaucoma).

According to the method, the device is manually operated to provide administration notice when the patient or caregiver rotates the device following a first administration to remind them of a second or next scheduled regimen. It has no alarm or means of audible notification, nor does it require any written or manual input of data.

In accordance with one embodiment of the present invention, there is provided a device for tracking medical dosing schedules. The device includes a generally tubular device that has an inner surface and an outer surface. The outer surface includes visual indicia related to dosing of a medication. The device is configured to be positioned around a container of the medication.

In accordance with one aspect of the present invention, there is provided a device, wherein the inner surface defines a region configured to receive a container for medicine.

In accordance with another aspect of the present invention, there is provided a device wherein the medicine is eye drops.

In accordance with another aspect of the present invention, there is provided a device wherein the outer surface is configured to convey information visually.

In accordance with another aspect of the present invention, there is provided a device wherein the outer surface has pictograms defined thereon.

In accordance with another aspect of the present invention, there is provided a device wherein the outer surface is divided into at least two regions that are generally evenly spaced around the outer surface of the ring and configured to convey information related to dosage regimens.

In accordance with another aspect of the present invention, there is provided a device wherein the dosing cycle occurs over a predetermined period of time.

In accordance with another aspect of the present invention, there is provided device wherein the predetermined period of time is 24 hours.

According to another embodiment of the present invention, there is provided a method for determining when a medical dose is to be administered. The method includes the steps of providing a generally cylindrical ring that has an inner surface and an outer surface, wherein the outer surface includes at least a first visual indicia and a second related to dosage, positioning the ring so that the first visual indicia is positioned such that it can be seen by an observer, reading the first visual indicia to determine when a first dose is due, administering the first dose, and positioning the ring so that the second visual indicia is positioned such that it can be viewed by an observer.

In accordance with another aspect of the present invention, there is provided the step of positioning a medicine container within the ring.

In accordance with another aspect of the present invention, there is provided the step of administering the first dose from the medicine container.

According to yet another embodiment of the present invention, there is provided a coordinated system for determining when medication doses should be administered. The system includes a first medicine container. A first indicator ring is associated with the first medicine container. The system also includes a second medicine container, and a second indicator ring is associated with the second medicine container.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a perspective view of a medication adherence reminder device according to one embodiment of the present invention;

FIG. 2 is a flattened, extended view of an outer surface of the device shown in FIG. 1;

FIG. 3 is a perspective view of a device according to an embodiment of the present invention wherein a first portion of the device is movable relative other portions of the device such that a marker defined on the first portion of the device can be positioned relative to the other portions of the device;

FIG. 4 is a perspective view of a device according to the present invention that is positioned around a medicine bottle according to the embodiment shown in FIG. 1 showing possible indicia;

FIG. 5 is a flattened, extended view of an outer surface of a device as shown in FIG. 4;

FIG. 6 is a perspective view of a device according to the present invention that is positioned around a medicine bottle according to the embodiment shown in FIG. 1;

FIG. 7 is a flattened, extended view of an outer surface of a device as shown in FIG. 6;

FIG. 8 is a perspective view of a device according to the present invention according to the embodiment shown in FIG. 1 that is positioned around a medicine bottle configured to contain pills;

FIG. 9 is a flattened, extended view of an outer surface of a device as shown in FIG. 8;

FIG. 10 is a perspective view of a device according to the present invention that is positioned around a medicine bottle;

FIG. 11 is a flattened, extended view of an outer surface of device as shown in FIG. 10;

FIG. 12 is a perspective view of a medication adherence reminder device according to one embodiment of the present invention;

FIG. 13 is a flattened, extended view of an outer surface of h device shown in FIG. 12;

FIG. 14 is a perspective view of a device according to the present invention that is positioned around a medicine bottle;

FIG. 15 is a flattened, extended view of an outer surface of a device as shown in FIG. 14; and

FIG. 16 is an exploded view of yet another embodiment of the present invention showing an outer ring and an inner sleeve positioned within the outer ring and the inner sleeve has a polygonal cross-section and is configured to receive a bottle therein such that the inner sleeve does not easily move relative to the bottle and the outer ring does not easily move relative to the inner sleeve and a marker formed on the inner sleeve can maintain position relative to an outer surface of the outer ring.

### DETAILED DESCRIPTION OF THE PREFERRED EMBODIMENTS

Embodiments of the present invention are directed to a device and method for determining when a dose of a medication has been administered and for indicating when a subsequent dose of the medicine is due. According to an illustrated embodiment, there is provided an interval device 10 that has indicia related to time of administration of prescribed doses and current status imprinted thereon.

Referring now to FIGS. 1 and 4, device 10 is a generally cylindrical tube that includes a wail 32 that defines an inner surface 34 and an outer surface 36. Inner surface 34 defines a region 38 configured to receive a container or bottle 14 configured to contain medicine in either liquid or solid form. By way of example and not limitation, such medicine configurations can include one of the following: tablet, powder, liquid, aerosolized liquid, inhalable powder, and a combination thereof. In the illustrated embodiment, device 10 has a circular horizontal cross section and bottle 14 also has a circular cross section. It should be appreciated that in other embodiments the cross section of device 10 or bottle 14 could be other shapes. By way of example and not limitation, such shapes can be one of the following: polygonal, elliptical, oval, square, oblong, and a combination thereof. The cross sections of device 10 can be a different shape than the cross section of bottle 14.

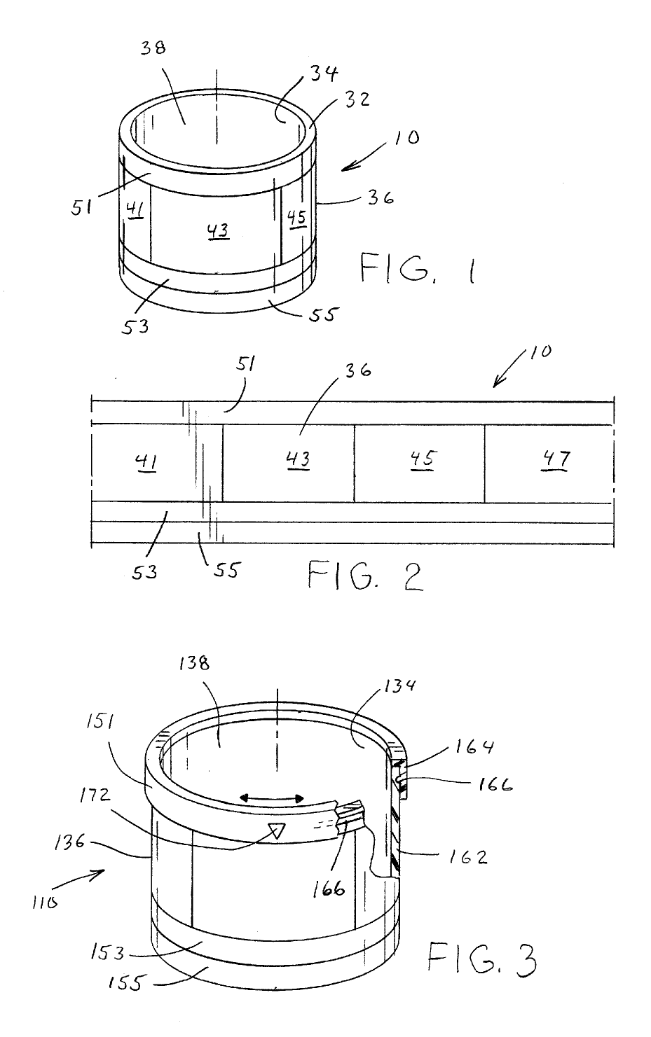

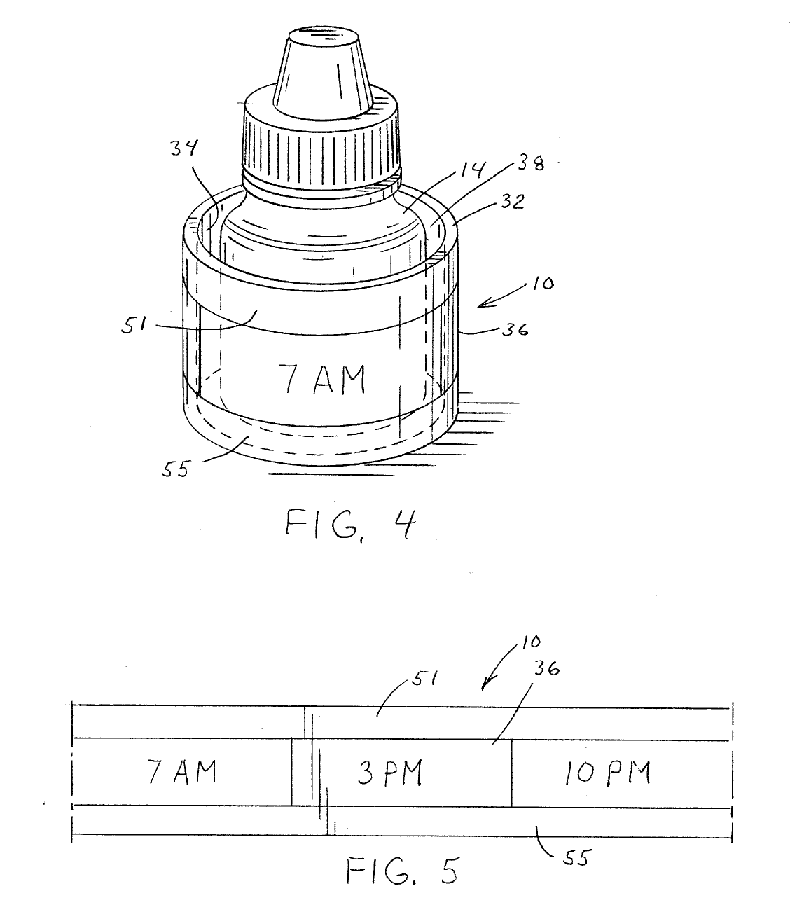

As shown in FIGS. 1 and 2, outer surface 36 of device 10 is configured to indicate the relative times of when dosings are due. Referring now to FIG. 2, there is shown a flattened view of outer surface 36. As shown in FIG. 2, a first reminder window 41, a second reminder window 43, a third reminder window 45, and a fourth reminder window 47 are defined on outer surface 36. Each of windows 41, 43, 45, and 47 is distinctively marked such that four different statuses are indicated. It should be appreciated that the current status of the medication can be in reference to an upcoming dose of the medication, i.e., the next dose. Alternatively, the current status can be in reference to a prior dose, i.e., the previous dose. In the illustrated embodiment, the current status for each window is an indication of the next time that a dose should be administered for a given day, if any. By way of example and not limitation, the distinctive markings can include one of the following means for conveying information: color, numeric, alphabetic, textual, symbolic, and a combination thereof. It should be appreciated that a device 10 can have two or more reminder windows. The number of reminder windows is determined based on the length of one dosage cycle and the number of doses within a dosage cycle. In one embodiment, a dosage cycle is one twenty-four hour day. It should be appreciated that one dosage cycle could be a predetermined number of hours or days.

Continuing to refer to FIGS. 1 and 2, device 10 can be configured to correlate with a cap by displaying a color or other indicia that is generally consistent or related to a color or other indicia displayed on a medicine container cap or lid in a band 51. Preferably, device 10 is color coded such that band 51 is at least partially of a color that generally matches the color of an associated cap. Bands 53 and 55 are also provided for color, text, or other indicia. In one embodiment, arrows are provided in band 55 that indicate the direction of the next relevant window and band 53 indicates the prescription name of the medication.

The device 10 can be easily incorporated into existing medicine packaging. By way of example and not limitation, such medicines can include the following: nasal spray, respiratory inhaler, eye drops, ear drops and a combination thereof. In one embodiment, device 10 is made of recycled materials, and is itself recyclable when the medication is discontinued.

In one embodiment, the freestanding device 10 is a generally tubular structure. In one embodiment, device 10 is configured to be freely movable relative to bottle 14 when device 10 is positioned around bottle 14. In this embodiment, the inside diameter of the ring is about 1 inch (2.54 cm), the height of the ring is about 1 inch (2.54 cm), and the wall thickness of the ring is about 0.045 inch (0.115 cm). The volume of typical ocular or otic containers sized for medicinal drops is 5-10 ml. Such bottles typically measure 0.875 inch (2.23 cm) diameter or smaller. In some cases, the bottle sizes differ from the above specification and can be larger or smaller and device 10 is configured accordingly. In one embodiment, device 10 is configured to fit snuggly around bottle 14 such that device 10 remains in place relative to bottle 14 unless sufficient force is applied to device 10. This configuration is useful when bottle 14, along with device 10, must be relocated or stored in a medicine bag or other non-stable situation.

The manufacturer's logo or branding can be defined on the inside and/or outside of the device, and the specific prescription name identified on the outside. Windows 41, 43, 45, and 47 can be preprinted with times, pictographs, text, annotated text, or other information. Alternatively, this information can be provided in windows 41, 43, 45, and 47 on device 10 by the patient or patient's caregiver at the time the medicine is prescribed or first administered.

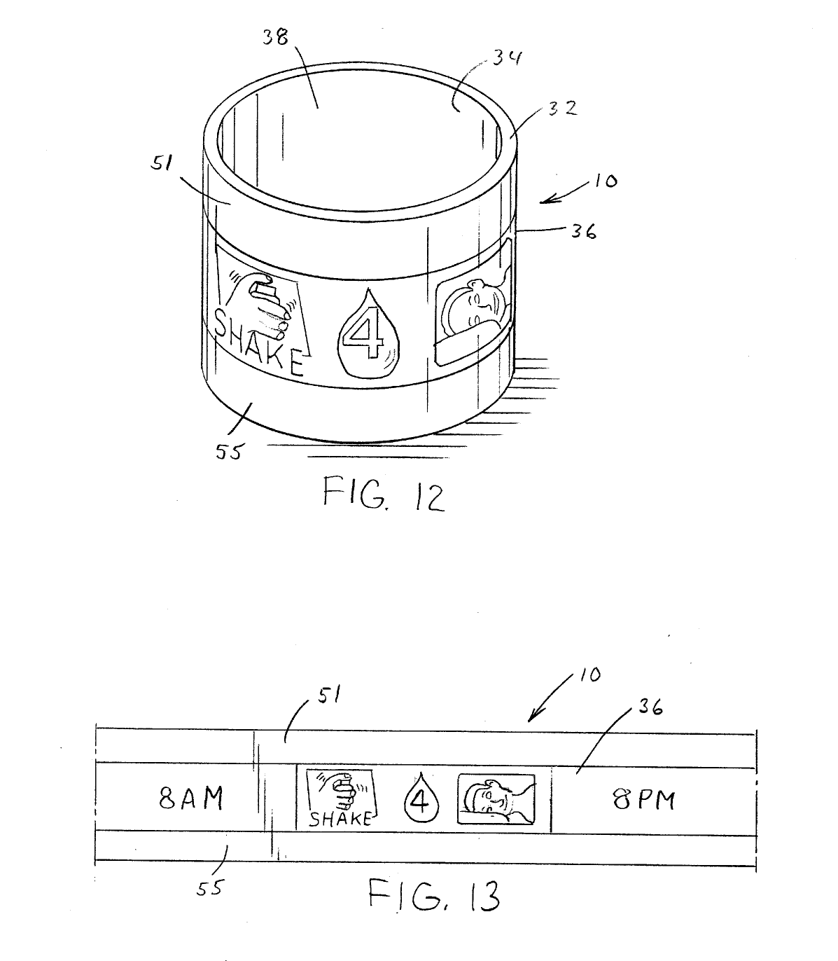

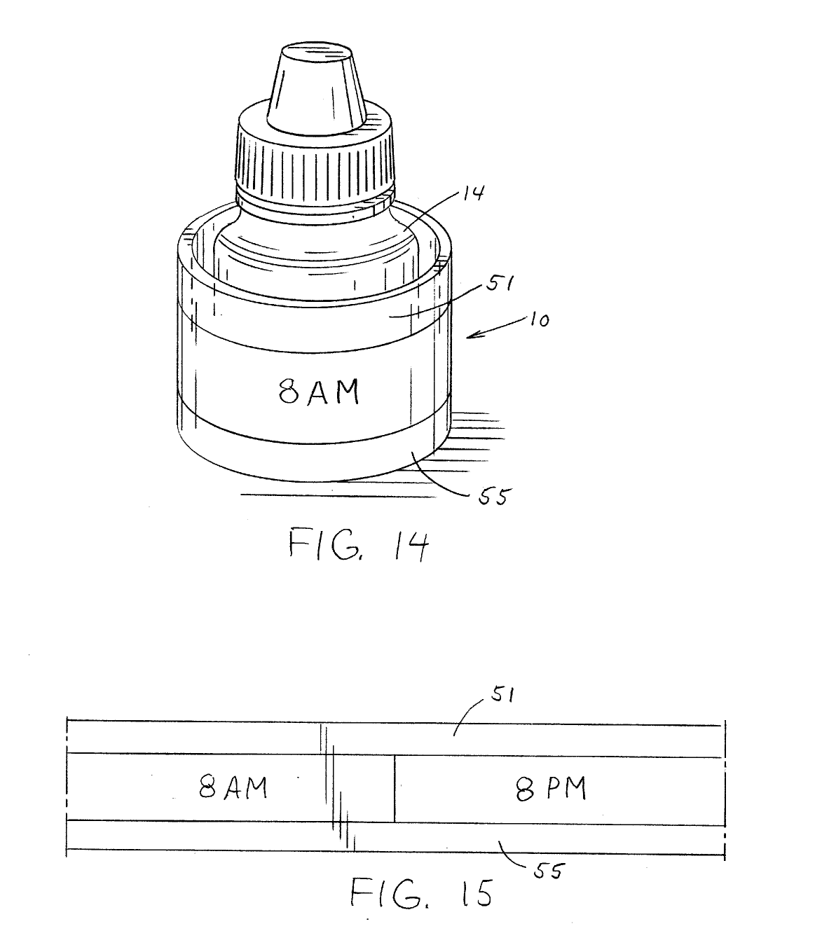

In one embodiment, the windows include pictograms as can be seen in FIGS. 12 and 13. In this regard, the pictograms show multiple hand attitudes holding a bottle illustrating compliance to instructions to shake well before administering 4 drops to an ear. It should be appreciated that other pictograms can be used to convey various messages. By way of example and not limitation thereof, the subject matter of such messages can include the following: quantity of drops, number of sprays, number of tablets, number of pills, patient position during dosing, hand attitude during dosing, and a combination thereof. Pictograms that convey such messages can include a quantity of stylized drops, similar to raindrops, as certain medication indicates multiple drops for each administration; pictograms of patient reclining in horizontal position, head on pillow, with the ear facing up; and pictograms of hand position. In some embodiments, the device 10 includes times indicated thereon that correlate with the recommended or prescribed times for administration of doses of medication.

By way of example and not limitation, device 10 can be comprised of one of the following materials: paper, plastic, metal, or a combination thereof. In a preferred embodiment, device 10 is formed of paper. In an alternative embodiment, device 10 is formed of plastic. It should be appreciated that in some situations, paper can be more practical because of lower cost, recyclability, ease of manufacture to specific product branding or identity, as well as packaging.

The present invention can be better understood by a description of the operation thereof. In this regard, the operation begins with positioning device 10 around an associated medicine container 14. Orienting device 10 such that an indication 14 of the current status of the medication is visible to the patient or person administering the medication comprises a second step. Reading the status to determine when the next dose of the medicine should be administered comprises a third step. Then, at the proper time, administering the correct dose of the medicine by removing the medicine container from the ring and then following the prescribed procedure for administering the medicine comprises a fourth step. Following administering of a dose, positioning device 10 such that a selected window indicating the current status is visible to the patient or person administering the medication. Then positioning the medicine container within device 10 completes the operation. In most situations the selected window indicating current status would display the prescribed time for the next administration of a dose. The operation is repeated at the next time indicated.

Multiple rings 10 can be used together to determine when each of more than one medications are to be administered. This embodiment can be provided as a kit from a single provider or assembled by the end user, i.e., patient or caregiver. This embodiment is useful when a complicated regimen that includes the coordinated administration of more than one medicine is prescribed. This embodiment can be better understood with reference to a hypothetical example. In this example, Chart 1 (below) indicates the prescribed number of doses per day for each of three medications during three weeks after surgery. Such a chart can be provided by a caregiver along with further instructions in many cases.

For this hypothetical the additional instructions include a prohibition against administering a dose of B within 5 minutes of a dose of medicine A or medicine C.

CHART 1

| | A | B | C |
|---|---|---|---|
| 1st week after surgery: | 4 | 2 | 1 |
| 2nd week after surgery: | 4 | 2 | 1 |
| 3rd week after surgery: | 0 | 1 | 0 |

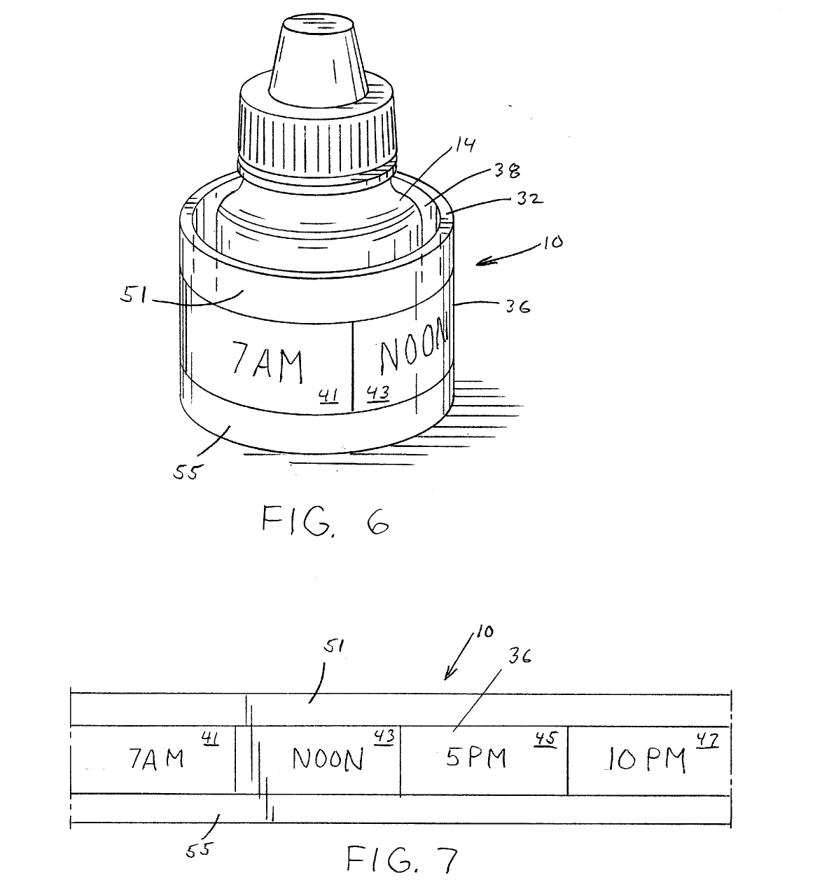

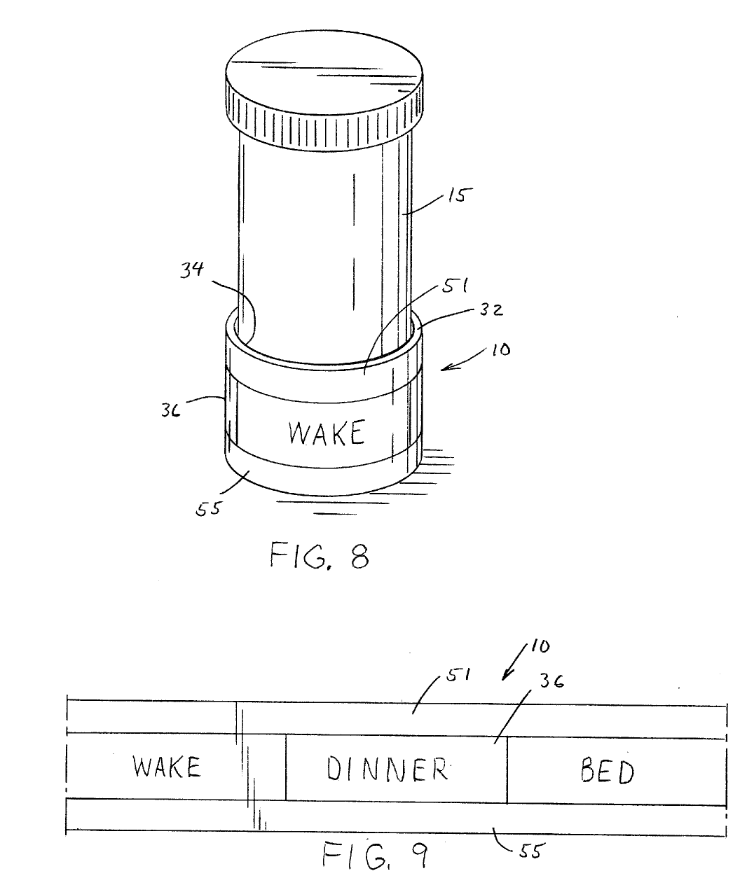

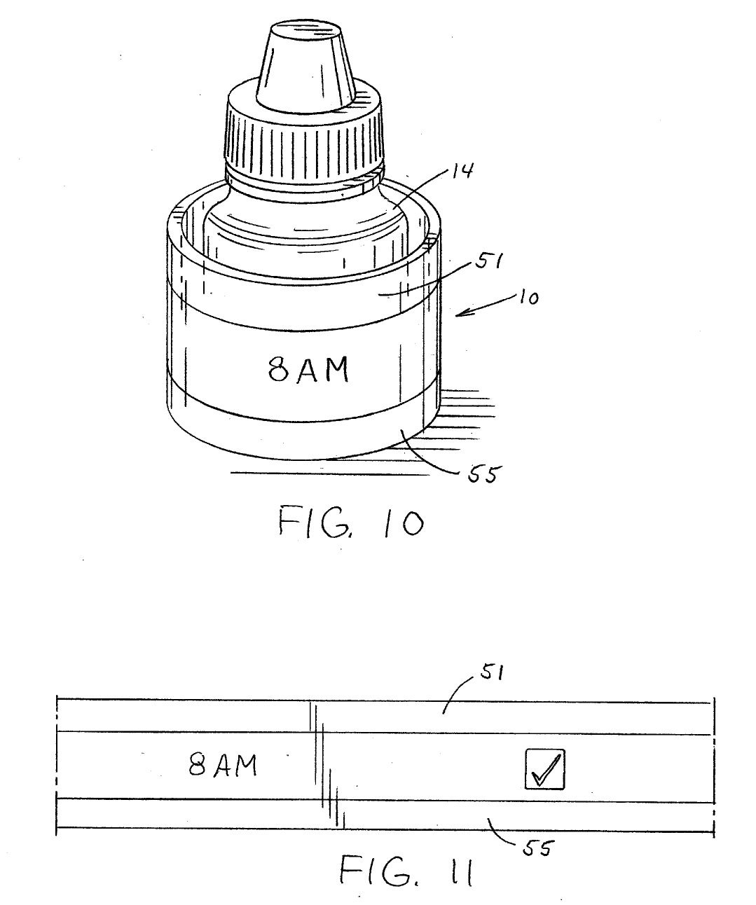

Referring now to chart 1, an antibiotic A is prescribed to be administered 4 times daily during the first week after surgery as shown in chart 1. Such an antibiotic can be used with the device 10 shown in FIGS. 1 and 2. Assuming the average waking day is 16 hours, and one dose is administered upon waking and one at bedtime, the patient would simply administer the dose and turn the freestanding ring 90° to indicate the time of the next dosage, for example: 7 am, noon, 5 pm and 10 pm as shown in FIGS. 6 and 7. Device 10 labeling can have arrows (not shown) indicating which way to turn the ring after each administration. Upon waking, with the indicator ring at the 7 am position, the first prescription dose is administered by the patient or caregiver. The bottle is replaced inside device 10 and positioned on the shelf such that the ‘noon’ position on device 10 is facing out thereby indicating noon as the next administration time. For 4 daily applications at relatively equal intervals, an alternative label may be preprinted with the words wake-up, lunch, dinner and bedtime. As a global scope alternative to language specific text in defining a time element, indicators such as clock faces, digital time or pictograms of sunrise/high sun/lowering sun/moon can be used.

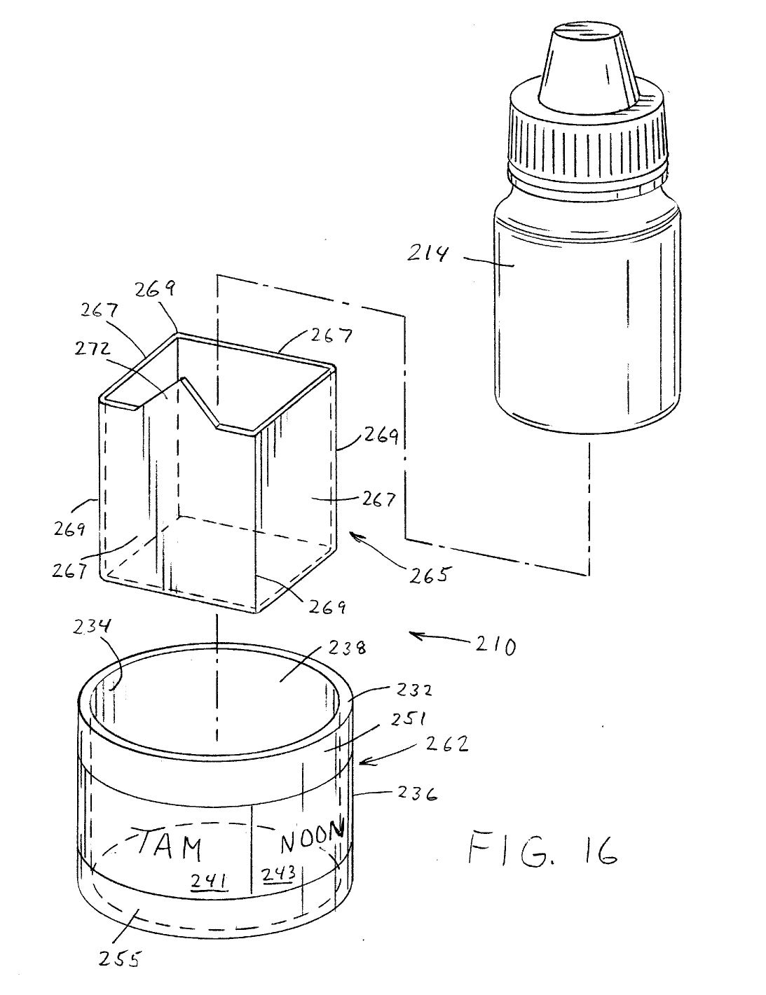

Referring to FIGS. 14 and 15 and continuing to refer to Chart 1, an anti-inflammatory B is also prescribed. For the first two (2) weeks after surgery, administration of medicine B is twice daily. At least 15 minutes away from the administration of either medication (A) or (C). It should be appreciated that this time can vary depending on the specific regimen and according to some regimens dosing of A and C are 5 minutes or more. To simplify the determination of administration times that meet the required criteria, in one embodiment preprinted rings 10 are provided. The preprinted designations 8 am and 8 pm on the color coded indicator ring are at 180° increments. The 8 am portion could be light in color indicating sunlight (or sunrise graphics) and the 8 pm portion could be darkened with white font for contrast (or moon graphics) indicating nighttime. Week three (3) or four (4) administration is changed to only once a day in the morning. The same ring device is used, but a separate color coded indicator label or decal is inserted in the packaging to place over the (original) first 2 week text. That label would read 8 am, and on the opposite side of the device at 180° spacing, would be a checkmark, thumbs-up or OK indicating the medication has already been administered for the day such as that shown in FIG. 11.

In a third example, a NSAID pain reliever C is administered. The indicator would read “wake”. On the opposite side of the tube at 180° would be a checkmark, thumbs-up or OK indicating the medication has been administered for the day. This ensures consistency of daily delivery and proper interval between various eye drops as the manufacturer isn't always the same.

Referring now to FIG. 3, the present invention provides an alternate embodiment device 110 that includes a first body 162 and a second body 164. Elements of this embodiment indicated by reference numbers in the 100 series can be understood by similarly numbered elements described above. Second body 164 is movably attached to first body 162 and is configured to be retained in positioned by first body 162 until purposefully moved relative to first body 162. In the embodiment shown, second body 164 is configured to engage an annular groove 166 defined in first body 162 such that sufficient friction exists between the two bodies to retain second body 164 in a predetermined position relative to first body 162.

A marker or indicia 172 is defined on second body 164. In the illustrated embodiment, indicia 172 is raised such that it can be seen and detected by touch. Second body 164 can be moved relative to first body 162 such that indicia 172 is associated with the window that indicates the current state. In this manner, even if device 110 were to become separated from an associated container of medicine or accidentally repositioned, the current state can be determined.

In another alternative embodiment shown in FIG. 16, a device 210 includes a first body 262 and a second body 265. Second body 265 is a tube having a polygonal cross-section, such as a square, and is configured such that at least two corners of second body 265 frictionally engage interior surface 234 of first body 264. Second body 265 includes walls 267 that are configured to engage a portion of an outer surface of bottle 214. In this manner, bottle 214 is retained in position relative to first body 264 by the frictional engagement of walls 267 with bottle 214 and the frictional engagement of corners 269 with inner surface 234. It should be appreciated that in some instances, walls 267 might deform such that at least a portion of a wall 267 engages inner surface 236. A marker 272 is formed on second body 265 and is configured to be visible alongside outer surface 236 of first body 264. The operation of device 210 can be understood with respect to the operation of device 110 described above wherein marker 272 is configured to indicate the current status of device 210.

It is believed that modern surgical procedures have dramatically improved the outcomes for most cataract patients, but paramount to such a continued success rate is effective post-surgery eye care as prescribed. It is believed that the present invention will improve the likelihood of a given patient having effective post-surgery eye care. Further, it is believed that the invention can improve outcomes of medical treatment related to other conditions. By way of example and not limitation, such other conditions can include the following: Age-Related Macular Degeneration (AMD), Glaucoma, Retinal Detachment, Bacterial Conjunctivitis, Pink Eye, Uveitis, Blepharitis (chronic infection of gland in eyelid), Chalazion (eyelid cyst), Corneal Ulcer, River Blindness, and a combination thereof.

The present invention is generally applicable to any type of medicine that is administered in multiple doses over time or is administered in one dose in sequence with doses of other medication. While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A device for tracking medical dosing schedules, the device comprising:
A generally tubular device that has an inner surface and an outer surface, wherein the outer surface includes visual indicia related to dosing of a medication wherein the device is configured to be positioned around a container of the medication.

2. The device according to claim 1, wherein the inner surface defines a region configured to receive a container for medicine.

3. The device according to claim 2, wherein the medicine is eye drops.

4. The device according to claim 1, wherein the outer surface is configured to convey information visually.

5. The device according to claim 4, wherein the outer surface has pictograms defined thereon.

6. The device according to claim 4, wherein the outer surface is divided into at least two regions that are generally evenly spaced around the outer surface of the ring and configured to convey information related to dosage regimens.

7. The device according to claim 6, wherein the dosing cycle occurs over a predetermined period of time.

8. The device according to claim 7, wherein the predetermined period of time is 24 hours.

9. A method for determining when medical dose is to be administered, the method including the steps of:
providing a generally cylindrical ring that has an inner surface and an outer surface, wherein the outer surface includes at least a first visual indicia and a second related to dosage,
positioning the ring so that the first visual indicia is positioned such that it can be seen by an observer,
reading the first visual indicia to determine when a first dose is due,
administering the first dose, and
positioning the ring so that the second visual indicia is positioned such that it can be viewed by an observer.

10. The method according to claim 9, further comprising the step of positioning medicine container within the ring.

11. The method according to claim 10, further comprising the step of administering the first dose from the medicine container.

12. A kit for providing a coordinated system for determining when medication doses should be administered, the kit comprising:
a first medicine container;
a first indicator ring associated with the first medicine container;
a second medicine container; and
a second indicator ring associated with the second medicine container.
